(19) United States
(12) Patent Application Publication
(10) Pub. No.: US 2014/0033581 A1
(43) Pub. Date: Feb. 6, 2014

(54) Check Presenter

(71) Applicant: John G. Myers, Coatesville, PA (US)

(72) Inventor: John G. Myers, Coatesville, PA (US)

(21) Appl. No.: 13/960,013

(22) Filed: Aug. 6, 2013

Related U.S. Application Data
(60) Provisional application No. 61/742,213, filed on Aug. 6, 2012.

(51) Int. Cl. G09F 1/10

(52) U.S. Cl. CPC G09F 1/10
USPC 40/1

(57) ABSTRACT

The application is directed to check presenters having contrasting colors/tones on the exterior sides thereof. The contrast permits a restaurant server to determine whether payment has yet been enclosed or not, so that payment may be processed in a timely manner and yet without the need to interrupt a customer to determine whether or not payment has yet been enclosed.

### CROSS-REFERENCE TO RELATED APPLICATIONS

This application claims the benefit of the priority of U.S. Provisional Patent Application No. 61/742,213, filed Aug. 6, 2012, which application is incorporated by reference herein in its entirety.

### BACKGROUND OF THE INVENTION

Restaurant servers place the classic uniform, one-color, check presenter at a customer's table with the guest check enclosed. The customer, at the customer's convenience, then opens the presenter, encloses either cash or credit card as payment, removes the customer's copy of the bill, and closes the presenter.

### SUMMARY OF THE INVENTION

The embodiments of the application address a need in the art for a check presenter that permits a restaurant server to know whether a customer has enclosed payment within the check presenter, without having to interrupt the customer who has not yet enclosed payment and without delaying the customer who has enclosed payment. Provided herein is a two-color/two-tone check presenter having a light color/tone on one exterior side of the presenter and a dark/opposing color/tone on the other exterior side of the presenter.

### BRIEF DESCRIPTION OF THE SEVERAL VIEWS OF THE DRAWING

FIG. 1 shows a perspective view of a check presenter as used in the art.

FIG. 2 shows a front view of the exterior front of a check presenter according to an embodiment of the invention.

FIG. 3 shows a front view of the exterior back of a check presenter according to an embodiment of the invention. The shading notes a color contrasting with that of FIG. 2.

### DETAILED DESCRIPTION OF THE INVENTION

The problem with the check presenters known in the art is that restaurant servers do not have X-ray eyes, nor are they mind readers. This results in a persistent problem for restaurant servers and customers alike when it comes time for customers to pay the bill. Conventionally, the server places the classic uniform-color check presenter at the customer's table with the guest check enclosed. The customer, at the customer's convenience, then opens the presenter, encloses either cash or credit card as payment, removes the customer's copy of the bill, and closes the presenter.

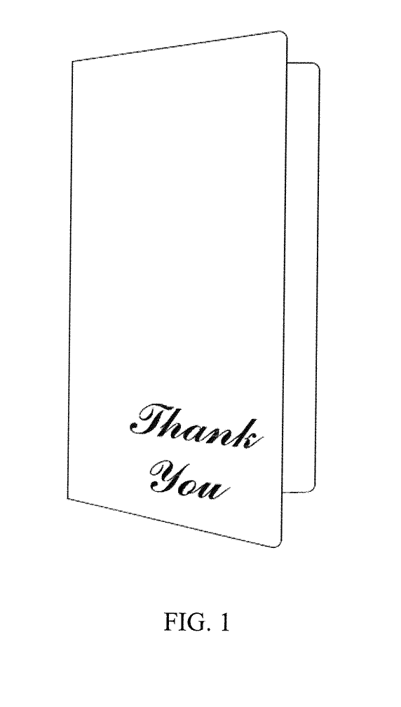

The problem arises when the server later returns or passes by the customer's table. The server cannot tell by looking at the uniform guest check presenter (see, e.g., FIG. 1) whether the customer has enclosed payment. There are no visual clues as to whether the customer's payment has yet been enclosed. The server can either interrupt the customer to inquire whether payment is enclosed, or assume the customer has not yet enclosed payment and therefore does not approach the table to retrieve the check presenter. If the server guesses wrong either way, the customer can be interrupted, inconvenienced, or delayed. If the customer has not yet enclosed payment but is approached by the server for the check presenter, the customer is then unnecessarily interrupted (or if the server mistakenly grabs the check presenter without asking and leaves the table without payment enclosed, such a misunderstanding can cause both embarrassment for the server and irritation/discomfort on the part of the customer). Or, the server can decide not to interrupt the customer, believing payment has not yet been enclosed and the customer is requiring of more time. However, if the customer has in fact already enclosed payment and is now waiting for the server to retrieve the check presenter, one of two situations will occur. Either the customer will be inconvenienced by being forced to get the server's attention that payment is ready and the check presenter should be retrieved, or the customer sits in silence wondering why the server has not yet come by to pick up the presenter and process the enclosed payment. These preventable situations result in added stress and work for the server, irritation and unnecessary delay for the customer, and slower than necessary turnover of tables for the restaurant.

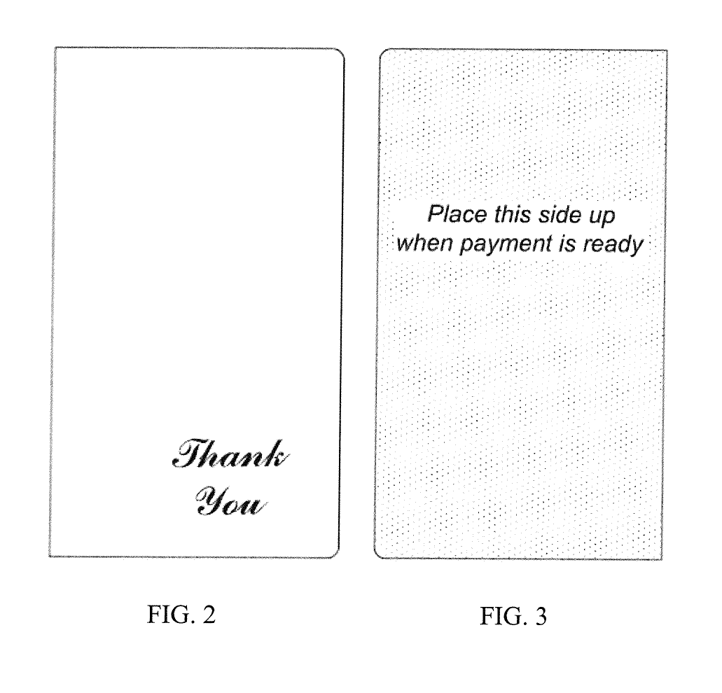

The embodiments described herein provide ‘low-tech’ solutions to the problem. A check presenter is provided having an exterior front (e.g, FIG. 2) and an exterior back (e.g., FIG. 3). The exterior front and exterior back are of opposing colors or tones. The presenter may further have wording, such as “Place this side up when payment is ready”, to signal the customer to place the exterior back up (face up) when payment is ready (see, for example, FIG. 3). The solution to the problem identified by the inventor is having the visual clue of one side light and one side dark, with the presenter face up (one color) meaning ‘payment is not ready’, and presenter face down (another color) meaning ‘payment is ready, please process’.

Embodiments having wording, such as “place this side up when payment is ready”, or other similar words, remind the customer to place the exterior back of the presenter ‘up’ so that it will be visible to the server. The contrasting color/tone serves as the visual clue to the server. The wording on the check presenter may be printed or embossed.

In one embodiment, the exterior front is dark in color/tone and the exterior back is light in color/tone. In another embodiment, the exterior front is light in color/tone and the exterior back is dark in color/tone.

In further embodiments, a credit card holder of the check presenter may be placed such as to entirely enclose the credit card within the presenter. This contrasts with check presenters in which the credit card holder is designed so that the credit card extends out from the inside of the presenter. The visual clue of the protruding credit card is not needed according to the embodiments of the invention, and poses a security risk especially when tables are seated on aisles.

A check presenter as described herein may be made according to any manufacturing process known in the art. If the presenter is made from a one-piece covering, then the front and back folds will have to go through separate dyeing processes. If the folds are stitched together, then the manufacturer will simply be stitching together different-colored folds instead of like-color folds, an easy solution. Single fold presenters will simply be different colors, front and back. Variances in the manufacturer's process may be determined by the material used to construct and cover the fold(s) and are known in the art and intended to be encompassed.

1. A check presenter comprising an exterior front and an exterior back, wherein said exterior front and exterior back are of opposing colors.

2. The check presenter according to claim 1, wherein the exterior back has thereon wording to signal the customer to place the exterior back up when payment is ready.

3. A check presenter comprising an exterior front and an exterior back, wherein said exterior front and exterior back are of contrasting tones.

4. The check presenter according to claim 3, wherein the exterior back has thereon wording to signal the customer to place the exterior back up when payment is ready.
